(19) United States
(12) Patent Application Publication
(10) Pub. No.: US 2009/0303746 A1
(43) Pub. Date: Dec. 10, 2009

(54) EDGE SHADOW REDUCING METHODS FOR PRISMATIC FRONT LIGHT

(75) Inventors: Lai Wang, Milpitas, CA (US); Gang Xu, Cupertino, CA (US); Ion Bita, San Jose, CA (US); Marek Mienko, San Jose, CA (US); Russell Gruhlke, Milpitas, CA (US)

Correspondence Address: KNOBBE, MARTENS, OLSON & BEAR, LLP, 2040 MAIN STREET, FOURTEENTH FLOOR, IRVINE, CA, 92614, US

(73) Assignee: QUALCOMM MEMS Technologies, Inc., San Diego, CA (US)

(21) Appl. No.: 12/478,519

(22) Filed: Jun. 4, 2009

Related U.S. Application Data
(60) Provisional application No. 61/058,828, filed on Jun. 4, 2008.

(51) Int. Cl. F21V 8/00; F21V 7/04

(52) U.S. Cl. 362/625

(57) ABSTRACT

Embodiments herein relate to light systems designed to reduce Moiré interference while simultaneously reducing dark regions due to the edge shadow effect. For example, configurations of light sources, light guides and turning features may direct light across a display while reducing Moiré interference.

### CROSS-REFERENCE TO RELATED APPLICATIONS

This application claims priority from U.S. Provisional Patent Application No. 61/058,828, filed on Jun. 4, 2008, which is incorporated herein by reference.

### BACKGROUND

1. Field of the Invention

Various embodiments herein relate displays and display technology, for example, to illumination systems for displays designed to reduce Moiré interference while simultaneously reducing dark regions that otherwise result from the edge shadow effect.

2. Description of Related Technology

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

In some embodiments, an illumination apparatus is provided comprising: a light source; a light guide having first and second ends and a length therebetween such that light from the light source injected into said first end of the light guide propagates toward the second end, said light guide comprising non-overlapping first and second regions along said second end; and a plurality of turning features in the light guide that reflect light incident thereon out the light guide, the turning features in said light guide generally facing a first region at said second end of said light guide such that light injected into said first end of said light guide is configured to be more efficiently reflected out from said first region of said light guide than from said second region, wherein said light source is configured to direct more light into said light guide towards a second region at said second end of said light guide rather than towards the first region of said light guide thereby increasing uniformity of light output across said light guide.

In some embodiments, an illumination apparatus is provided comprising a light guide having first and second ends and a length therebetween such that light injected into said first end propagates toward a second end, said light guide having a width and thickness; and a plurality of turning features disposed on a first side of the light guide, said turning features comprising sloping sidewalls that reflect light incident thereon out a second side of the light guide, said turning features having an orientation that is substantially nonparallel to the first end of the light guide, wherein said width of said light guide decreases along at least a portion of the length of said light guide.

In some embodiments, an illumination apparatus is provided comprising: a spatial light modulator array having a length and a width; a light guide having first and second ends and a length therebetween such that light injected into said first end propagates toward a second end, said light guide having a width and thickness; and a plurality of turning features disposed on a first side of the light guide, said turning features comprising sloping sidewalls that reflect light incident thereon out a second side of the light guide, said turning features having an orientation that is substantially nonparallel to the first end of the light guide, wherein said width of said light guide is greater than the width of said modulator array.

In some embodiments, an illumination apparatus is provided comprising: a light guide having first and second ends and a length therebetween such that light injected into said first end propagates toward a second end, said light guide having a width and thickness; and a plurality of turning features disposed on a first side of the light guide, said turning features comprising sloping sidewalls that reflect light incident thereon out a second side of the light guide, each of said turning features comprising a plurality of linear segments, at least one first segment of said plurality of segments being oriented obliquely with respect to at least one second segment of said plurality of segments, wherein none of said segments intersect more than two other turning features.

In some embodiments, an illumination apparatus is provided comprising: a light guide having first and second ends and a length therebetween such that light injected into said first end propagates toward a second end; and a plurality of diagonal turning elements, each diagonal turning element comprising a plurality of turning features disposed on a first side of the light guide, said turning features comprising sloping sidewalls that reflect light incident thereon out a second side of the light guide.

In some embodiments, an illumination apparatus is provided comprising: a light guide having first and second ends and a length therebetween such that light injected into said first end propagates toward a second end; and a plurality of diagonal turning elements, each diagonal turning element comprising a plurality of turning features disposed on a first side of the light guide, said turning features comprising sloping sidewalls that reflect light incident thereon out a second side of the light guide, wherein one side of the turning features in each diagonal turning element being arranged along a line, the line being non-normal and non-parallel to the length of the light guide, and wherein the orientation of said turning features in said diagonal turning elements are different from the orientation of the respective diagonal turning element.

In some embodiments, an illumination apparatus is provided comprising: a light guide having first and second ends and a length therebetween such that light injected into said first end propagates toward a second end; and a plurality of turning features disposed on a first side of the light guide, said turning features comprising sloping sidewalls that reflect light incident thereon out a second side of the light guide, said turning features comprising linear paths orthogonal to the length of the light guide, said turning features having a first length, said turning features having two ends that do not contact other turning features or ends or edges of the light guide, wherein said first length is configured such that the individual turning features are undistinguishable by an unaided human eye.

In some embodiments, an illumination apparatus is provided comprising: a means for producing light; a means for guiding light having first and second ends and a length therebetween such that light from the light-producing means injected into said first end of the light-guiding means propagates toward the second end, said light-guiding means comprising non-overlapping first and second regions along said second end; and a plurality of means for turning light in the light-guiding means that reflect light incident thereon out the light-guiding means, the light-turning means in said light-guiding means generally facing a first region at said second end of said light-guiding means such that light injected into said first end of said light-guiding means is configured to be more efficiently reflected out from said first region of said light-guiding means than from said second region, wherein said light-producing means is configured to direct more light into said light-guiding means towards a second region at said second end of said light-guiding means rather than towards the first region of said light-guiding means thereby increasing uniformity of light output across said light-guiding means.

In some embodiments, an illumination apparatus is provided comprising: means for guiding light having first and second ends and a length therebetween such that light injected into said first end propagates toward a second end, said light-guiding means having a width and thickness; and a plurality of means for turning light disposed on a first side of the light-guiding means, said light-turning means comprising means for reflecting light incident thereon out a second side of the light-guiding means, each of said light-turning means comprising a plurality of linear segments, at least one first segment of said plurality of segments being oriented obliquely with respect to at least one second segment of said plurality of segments, wherein none of said segments intersect more than two other segments.

In some embodiments, an illumination apparatus is provided comprising: means for guiding light having first and second ends and a length therebetween such that light injected into said first end propagates toward a second end; and a plurality of diagonal means for directing light, each diagonal light-directing means comprising a plurality of means for turning light disposed on a first side of the light-guiding means, said light-turning means comprising means for reflecting light incident thereon out a second side of the light-guiding means.

In some embodiments, an illumination apparatus is provided comprising: means for guiding light having first and second ends and a length therebetween such that light injected into said first end propagates toward a second end; and a plurality of means for turning light disposed on a first side of the light guiding means, said light turning means comprising means for reflecting light incident thereon out a second side of the light guide, said light turning means comprising linear paths orthogonal to the length of the light guiding means, said light turning means having a first length, said light turning means having two ends that do not contact other light turning means or ends or edges of the light guiding means, wherein said first length is configured such that the individual light turning means are undistinguishable by an unaided human eye.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 shows an illumination system comprising a light guide with turning features. A Moiré pattern may be caused by overlapping such a light guide with a pixel array having pixels arranged in rows and columns wherein the columns are generally parallel to the vertically arranged turning features.

FIG. 9 shows an illumination system comprising a light guide with turning features rotated with respect to a pixel array. Rotation of a light guide with respect to a pixel array results in what may be referred to as the “edge shadow effect.”

FIG. 10 shows an illumination system comprising a light guide and a light bar extending beyond an active area of a pixel array which may reduce the edge shadow effect.

FIG. 11 shows an illumination system comprising a light guide and a light bar extending beyond an active area of a pixel array, here the light guide has a width on a first end that is wider than a width of a second end, the first end being closer to the light bar than the second end.

FIG. 12 shows an illumination system comprising a light source with an asymmetric distribution created by a side lobe.

FIGS. 13A-D show light guides comprising a light turning features comprising a plurality of segments, at least one of the segments oriented obliquely with respect to at least one other said segment.

FIG. 14 shows a light guide comprising a plurality of diagonal turning elements, each diagonal turning element comprising a plurality of turning features.

### DETAILED DESCRIPTION OF THE CERTAIN PREFERRED EMBODIMENT

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

In some embodiments, an illumination system comprises a light source and a light guide. Light from the source can enter the light guide and spread across a wide area and be directed onto an array of display elements by a plurality of turning features in the light guide. However, superposition of the light guide with an array of display elements can cause Moiré interference. Turning features of the light guide can be rotated with respect to the array to reduce the interference, but a dark region then commonly occurs in a region of the display. Embodiments disclosed herein relate to configurations of a light source and/or a light guide that may reduce the dark region. Additional embodiments disclosed herein relate to configurations of turning features of the light guide that may reduce the dark region.

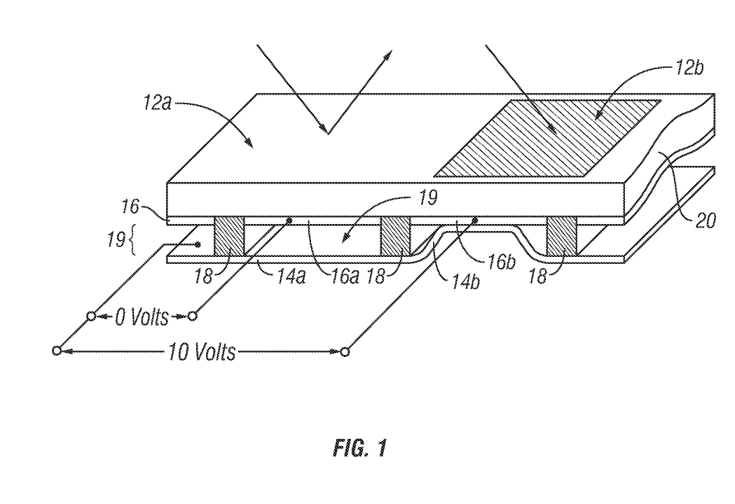

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

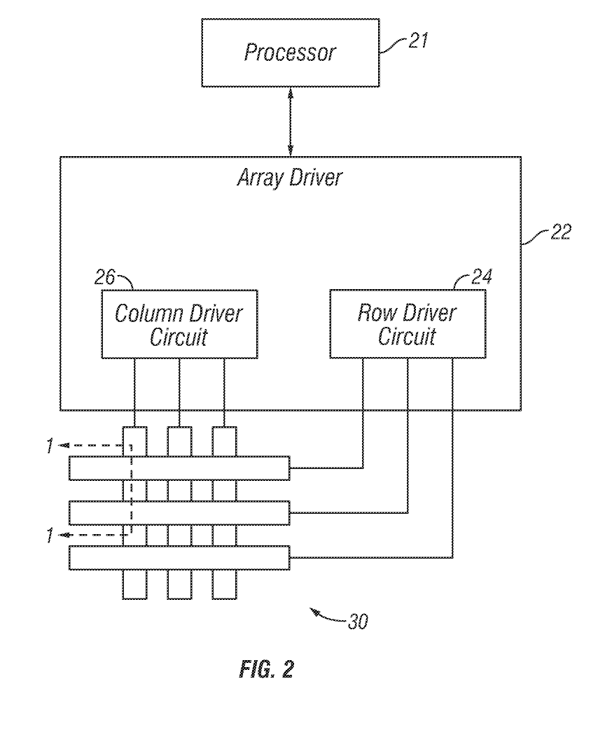

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

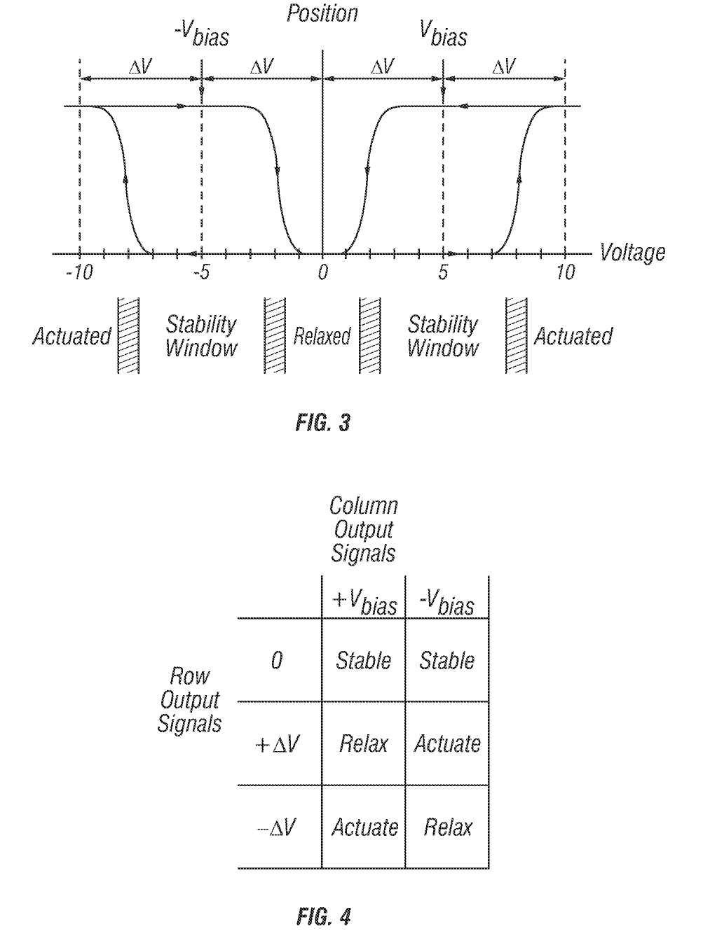

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

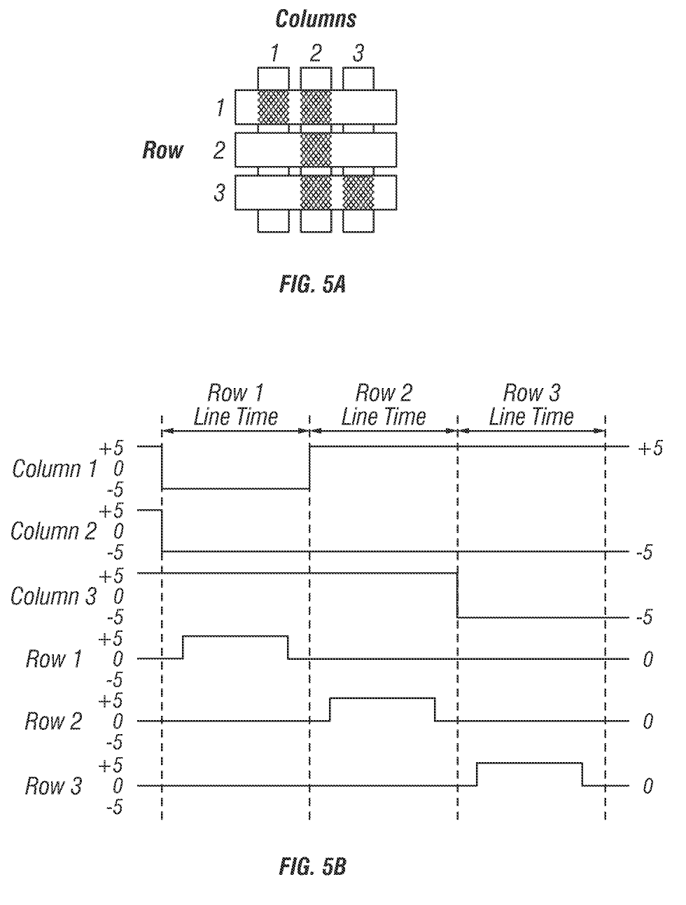

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

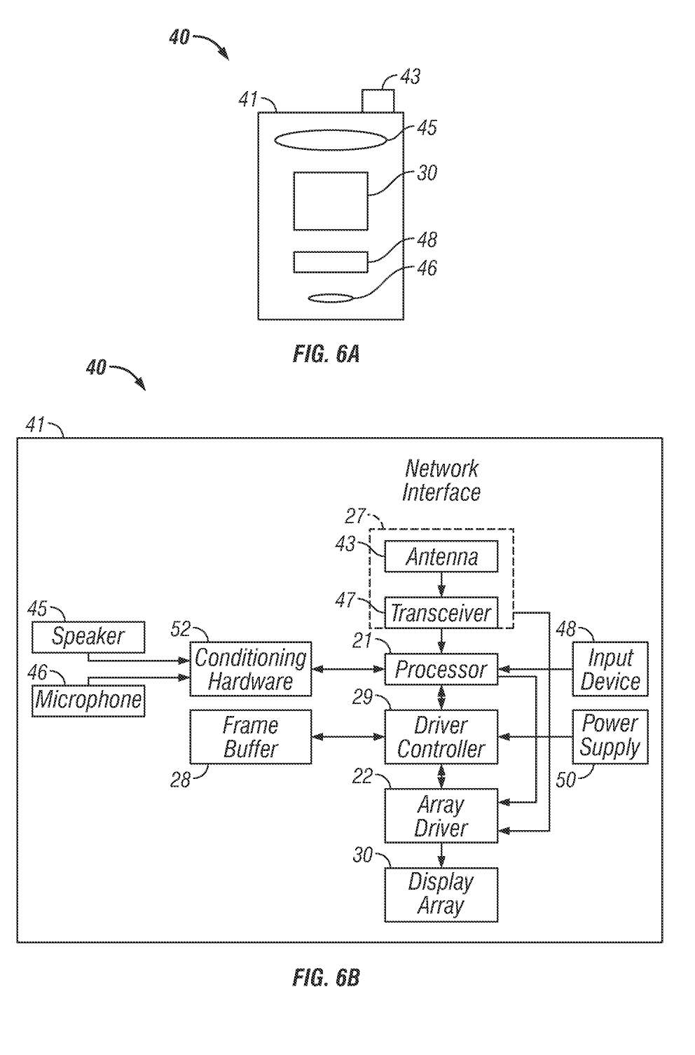

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

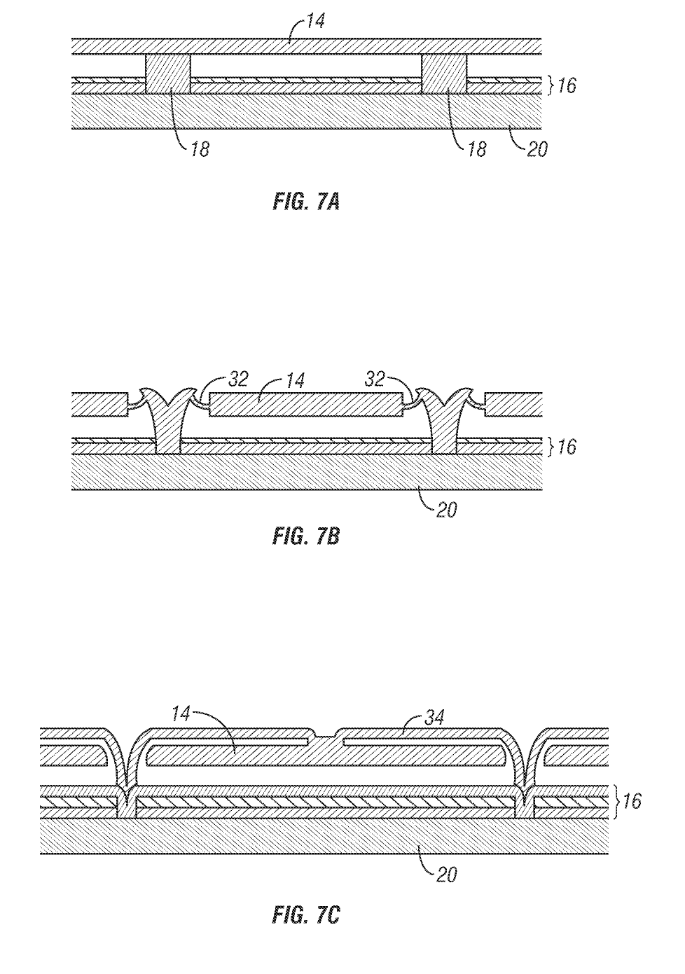

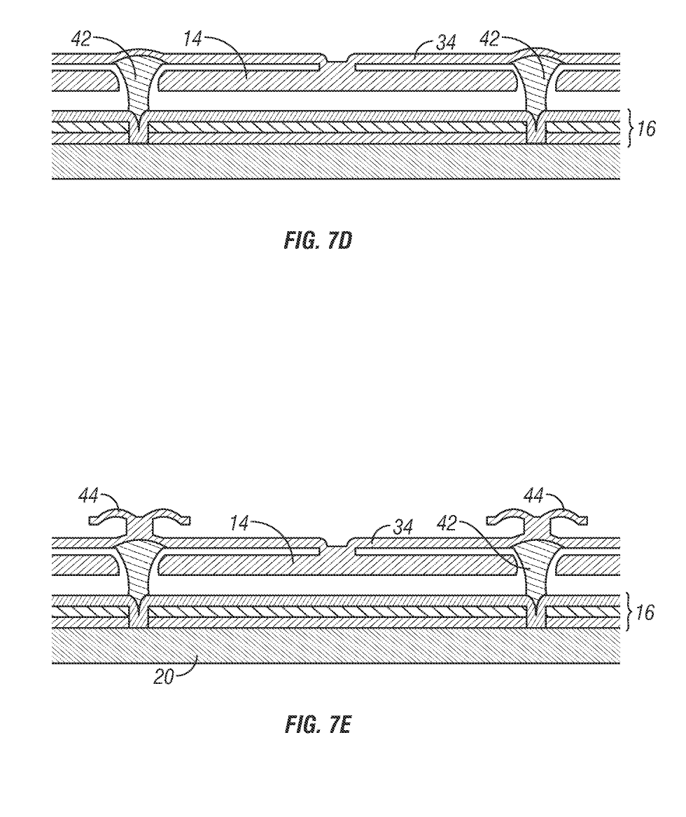

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

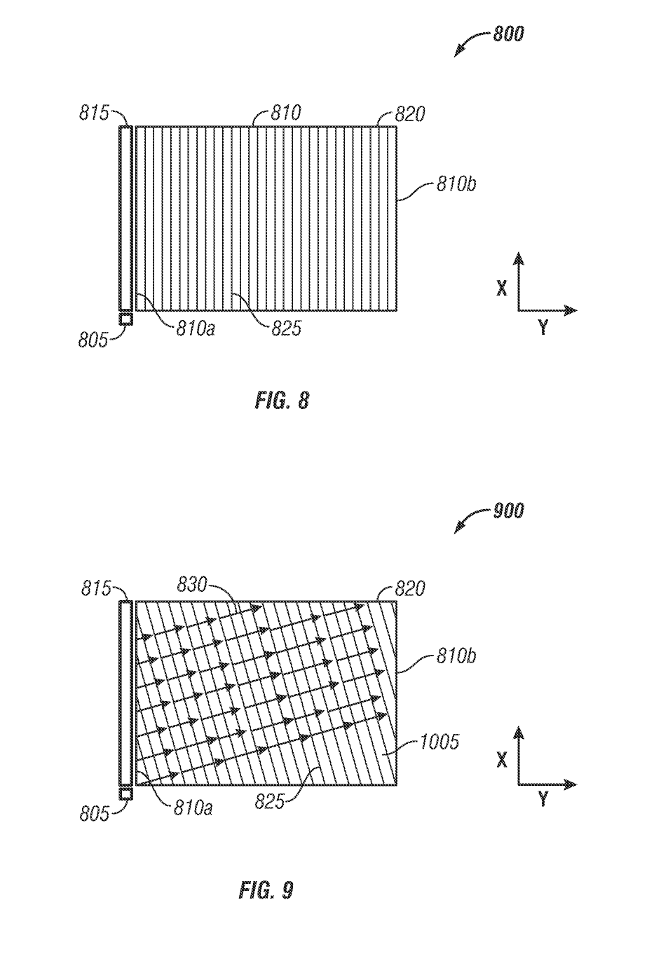

As shown in FIG. 8, in some embodiments, an illumination system 800 comprises a light source comprising light emitter 805 and a light guide 810. In some embodiments, the light emitter 805 is accompanied by a light bar 815, configured to transform light from a point source (e.g., a light emitting diode (LED)) into a line source. The light source may further comprise the light bar 815. The light bar 815 comprises substantially optically transmissive material that guides light therein via total internal reflection. Light from the emitter 805 injected into the light bar 815 propagates along the length of the bar and is ejected out of the bar over the length of the bar, for example, by extractors arranged along the length of the light bar 815. The ejected light enters a first end 810a of the light guide 810 and travels towards a second end 810b, which may be an end opposite of the first end 810a. The light guide 810 also comprises substantially optically transmissive material that guides light therein via total internal reflection. The light bar 815 may be substantially parallel to the first end 810a of the light guide 810 such that light ejected across the length of the light bar 815 is injected across the width of the light guide 810. The light is consequently spread across a wide area and directed onto an array of display elements 820 rearward (e.g. below) the light guide 810. (In FIG. 8, the light guide 810 is superimposed over the array of display elements 820 and thus although line 820 is shown indicating the location of the array of display elements, the display elements themselves are not shown.) A light guide 810 having turning features 825 thereon may be used to direct the light onto the display elements 820. The turning features 825 are configured to turn at least a substantial portion of light introduced into the first end 810a of the light guide 810 and to direct the portion of light out a second opposite side of the light guide 810. The turning features may comprise, for example, prismatic features. The turning features 825 may include sloping sidewalls that reflect light by total internal reflection. The turning features 825, comprising, for example, grooves in the light guide, may include planar sloping sidewalls (facets). Turning features may be continuous or may appear to be continuous by the human eye. Turning features may extend across a width of the light guide 810 and/or across a width of a display element matrix 820. The grooves may be filled with a material forming an interface which, in some embodiments, forms one or more facets. The light ejected from the light bar 815 is coupled into an edge of the light guide 810 and propagated within the light guide 810. The turning features 825 eject the light from the light guide 810 over an area corresponding to a plurality of display elements 820 comprising, for example, spatial light modulators and/or interferometric modulators.

In FIG. 8, the turning features in light guide 810 are periodic (e.g., in the y-direction). The turning features 825 may be parallel to each other as shown. In some embodiments, the turning features are, for example, semi-periodic or aperiodic. The light turning features extend in the vertical direction (x-direction) in the example shown in FIG. 8 and are periodic in the horizontal direction (y-direction). The plurality of display elements 820 may comprise an array of display elements arranged in rows and columns, for example, arranged along the y- and x-directions, respectively. Accordingly, in FIG. 8, the display elements 820 are also periodic (e.g., in the x- and y-directions). In some embodiments, the display elements are, for example, semi-periodic or aperiodic. The superposition of the light guide 810 with the periodic turning features and the array of pixels, which is also periodic, can cause Moiré interference. As is well known, a fringe pattern referred to as a Moiré pattern can be formed when periodic structures are superimposed. The Moiré interference pattern can be distracting and an unpleasant visual effect of the display. The pattern may degrade uniformity and/or contrast of the display. This problem can be reduced or eliminated by adjusting the orientation of the turning features in the light guide 810 with respect to the pixel array 820. For example, the turning features in light guide 810 can be arranged such that the turning features 825 extend at an angle not parallel with the rows or columns of display elements.

FIG. 9 shows an illumination system 900 in which turning features 825 (comprising light-turning elements) of the light guide 810 are rotated counter-clockwise from vertical. Thus, turning features 825 of the light guide 810 are nonparallel to the length of the light bar 815. The turning features 825 may thereby be nonparallel and/or nonorthogonal to rows and/or columns of a pixel array 820. This rotation is sufficient to reduce the Moiré interference pattern to a negligible level. However, rotating the turning features 825 with respect to the pixel array 820 can cause light injected into the light guide 810 to be more efficiently reflected out from one region of the light guide 810 than from another region of the light guide 810, and may generate a dark area (e.g., triangle-shaped area) in a region (e.g., a corner) of the display when the display is viewed at substantially normal angles. This artifact is referred to herein as the “edge shadow effect.” The effect typically becomes apparent as the viewing angle increases with respect to normal from the light guide. Angles greater than 20° may produce more pronounced effects. In the example shown in FIG. 9, the dark triangle shaped area 1005 is present at the bottom right-hand corner of the display. Without subscribing to any particular scientific theory, one possible reason this artifact occurs is because light propagating more normal to the orientation of the light turning feature is more effectively turned out of the light guide and into the viewing cone. Less light propagates normal to the orientation of the light turning feature in the dark triangular region 1005 because of the orientation of the facets and the geometry of light bar and light guide.

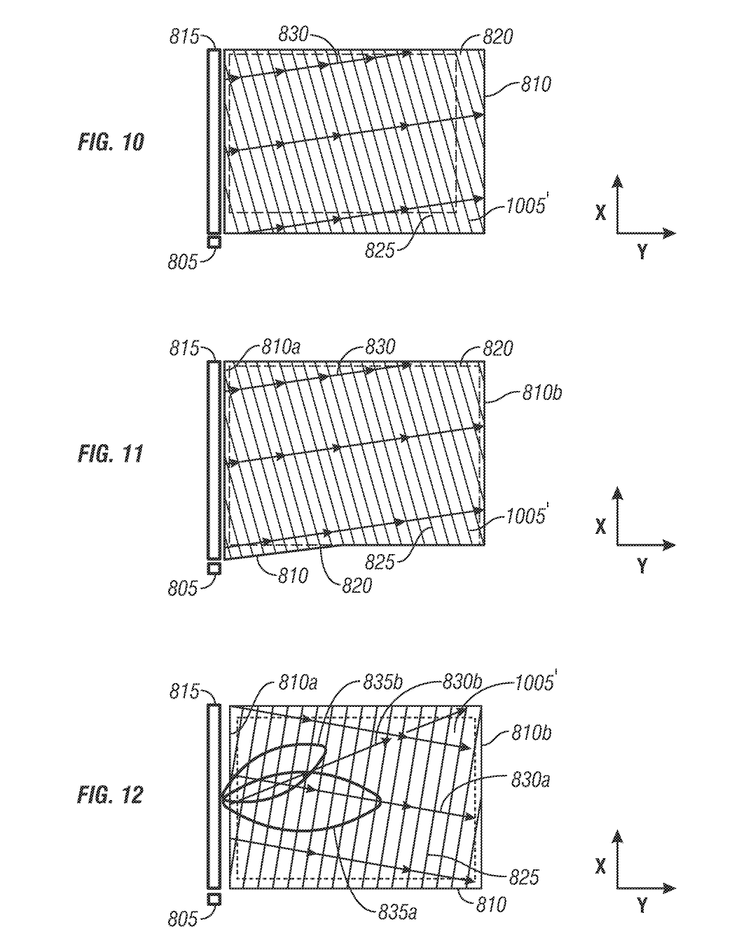

FIG. 10 shows an embodiment where the light guide 810 and the light bar 815 extend beyond an active area of the pixel array 820. In the embodiment shown, the turning features 825 are nonparallel to the first end 810a of the light guide 810. The active area refers to an area of the array 820 capable of modulating light. For interferometric modulators, this active area may correspond to an area where light is modulated and reflected back to the viewer and accordingly corresponds to the modulated region visible to the viewer. The array of display elements or pixel array 820 can be characterized by a length and a width, wherein the width is a distance measure along the long axis of the light bar 815 (in the up and down directions in FIG. 10) and the length is a distance measure along a direction perpendicular to the long axis of the light bar 815 (in the left and right directions in FIG. 10). The terms width and lengths are selected for convenience only and the corresponding directions could be otherwise named. Similarly, the light guide 810 can be characterized by a length and a width in the same directions. The light bar 815 can be characterized by a length, which is a distance measure along the long axis of the light bar 815 (in the up and down directions in FIG. 10). The length of the light bar is approximately equal to the width of the light guide in this case.

In one embodiment, the length of the light bar 815 and the width of the light guide 810 are larger than the width of an active area of the pixel array 820. In one instance, the length of the light guide 810 is greater than the length of the active area of the pixel array 820, while in other instances, it is substantially the same. The light bar 815 and the light guide 810 may extend beyond the spatial extent of the pixel array 820 to move the dark triangular region 1005 beyond the expanse of the array of display elements. A length of the light bar 815 and/or a width of the light guide 810 may be larger than the width of an active area of the pixel array 820 by an amount greater than or equal to about ΔW, where ΔW is defined as the product of the length (L) of the pixel array 820 and the tangent of the rotation angle θ of the turning features 825. Thus, in some embodiments, a length of the light bar 815 and/or a width of the light guide 810 may be at least about 1%, 2%, 3%, 5%, 10% or 20% larger than the width of the pixel array 820. A length of the light bar 815 and/or a width of the light guide 810 may be at least about 1, 2, 3, 5, or 10 mm larger than a width of the pixel array 820. For example, if the light bar 815 is oriented vertically, and the turning features 825 are rotated counter-clockwise (less than 90°) from vertical, the light bar 815 and the light guide 810 may extend in the downwards direction. Thus, sufficient light propagates in the direction normal to the facets from the extended part of the light bar 815 to reach the corner of the pixel array 820 that would otherwise be dark. Accordingly, in the example shown in FIG. 10, light directed at an angle above the horizontal may be incident on the turning features 825 above the bottom right hand corner of the pixel array 820 as a result of the increased width of the light guide 810. Alternatively, if the light bar 815 is oriented vertically, and the turning features 825 are rotated clockwise (less than 90°) from vertical, the light bar 815 and the light guide 810 may extend in the upwards direction in order to provide additional light to a portion of the light guide 810 over the top right hand corner of the pixel array 820. Accordingly, in this instance, light directed at an angle below the horizontal may be incident on the light turning features in the top right hand corner as a result of the increased width of the light guide 810.

In some embodiments, the light guide 810 is substantially rectangular. In other embodiments, such as that shown in FIG. 11, the light guide is not substantially rectangular. The non-rectangular shape may serve to direct light from an extended light bar 815 to what would otherwise be a dark region 1005′ due to the edge shadow effect. The non-rectangular shape may also serve to direct light from the light bar 815 to the otherwise dark region 1005′ at an angle more normal to the length of the turning feature 825 in the dark region. This embodiment may be advantageous over the embodiment shown in FIG. 10, as it may reduce manufacturing costs by reducing the amount of material needed for the light guide 810. The first end 810a of the light guide 810 adjacent to the light bar 815 may be wider than a second end 810b opposite of the first end 810a. Thus, the width of the light guide 810 may decrease along at least a portion of the light guide 810. A length of the light bar 815 and/or a width of the light guide 810 may be larger than the width of an active area of the pixel array 820 by an amount greater than or equal to about ΔW, where ΔW is defined as the product of the length (L) of the pixel array 820 and the tangent of the rotation angle α of the turning features 825. Thus, in some embodiments, the first end 810a is at least about 0.5%, 1%, 2%, 5%, 10% or 20% wider than the second end 810b. In some embodiments, the first end 810a is at least about 1, 2, 3, 5, 10 mm larger than the second end 810b. In some embodiments, the widths of the light guide across the length of the light guide are characterized by a variability of at least about 1%, 2%, 5%, 10%, 20%, 30%, 40% or 50% relative to the average width. Also, the length of the light bar 815 may be longer than the width of the light guide at the second end 810b. As shown in FIG. 11, in the otherwise dark triangular region 1005′, light directed at an angle inclined above the horizontal may be incident on the light turning features as a result of the increased width of the light guide 810 at the first end 810a proximal to the light bar 815.

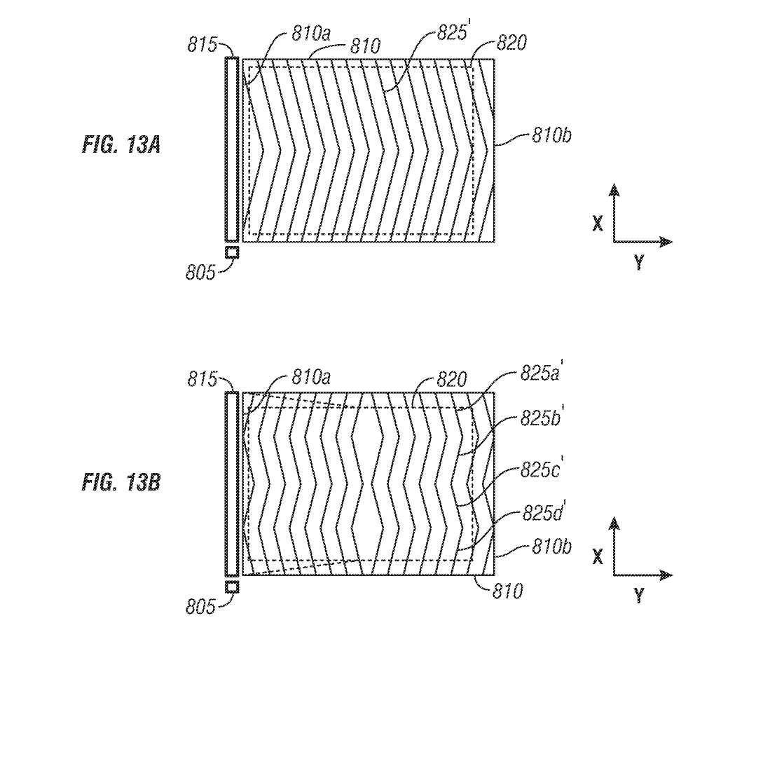

As shown in FIG. 12, a light source may be configured to provide an asymmetric light distribution with more light directed to what would otherwise be a dark region 1005′ due to the edge shadow effect. Thus, turning features 825 may have an orientation as described herein to reduce Moiré fringes, and the light source may be configured as described in this embodiment (e.g., with an asymmetric light distribution) to improve uniform brightness. In some embodiments, the asymmetric light distribution comprises one in which at least about 5%, 10%, 20%, 30%, 40%, 50% or 100% more light is directed towards an otherwise dark region as compared to a substantially symmetric light source. In one instance, a light guide 810 has non-overlapping first and second (e.g. upper and lower) regions, both of which are positioned along the second end 810b. The first and second regions may be the corners, such as opposite upper and lower right-hand corners as shown in the example in FIG. 12. In particular, in FIG. 12, the first and second regions correspond to the bottom right corner and the top right corner, respectively, of the light guide 810. The turning features 825 may be oriented to have a normal vector pointing from the features more toward the first lower region than the upper second region of the light guide, which may potentially result in a triangular dark region 1005 as a result of the edge shadow effect. However, the light source may be configured to provide an asymmetric light distribution with more light directed to the region 1005′ that would otherwise be dark, shown in the example in FIG. 12 in the upper right corner. Lobes 835a and 835b in different directions may provide an asymmetric distribution of light output from the light bar 815. In one instance, light is emitted into the light guide 810 in a primary lobe 835a and a secondary lobe 835b. Light 830b emitted from one lobe (e.g., the secondary lobe 835b) may propagate towards the otherwise dark region 1005′. Light 830a emitted from one lobe (e.g., the primary lobe 835a) may propagate in a direction normal to the turning features 825. The light source may be configured to direct more light towards a second region 1005′ (e.g., a region that would otherwise be a dark region) than to another region, thereby increasing uniformity of light output across the light guide. The light source may therefore preferentially direct initially-emitted light 830 towards the first upper region 1005′ of said light guide 810 rather than towards the second lower region of said light guide 810. Accordingly, the lobes are directed more toward the upper right corner than the lower right corner.

The light bar 815 may be configured to emit light 830 in a plurality of directions represented by lobes such as shown in FIG. 12. The first lobe may be directed substantially normal to the first end 810a of the light guide 810 adjacent to the light bar 815. A second (and, for example, a third) lobe may be substantially non-normal to the first end 810a. In some instances, the first lobe is substantially non-normal to the first end 810a as well. Thus, the average light emitted from the light bar 815 and/or the direction of greatest light intensity may be in a direction substantially non-normal to the first end 810a, to the length of the light bar 815, to the width of the light guide 810, and/or to the width of the pixel array 820. The average light emitted from the light bar 815 may be directed towards what would otherwise be a dark region due to the edge shadow effect. Other configurations with other light distributions are also possible.

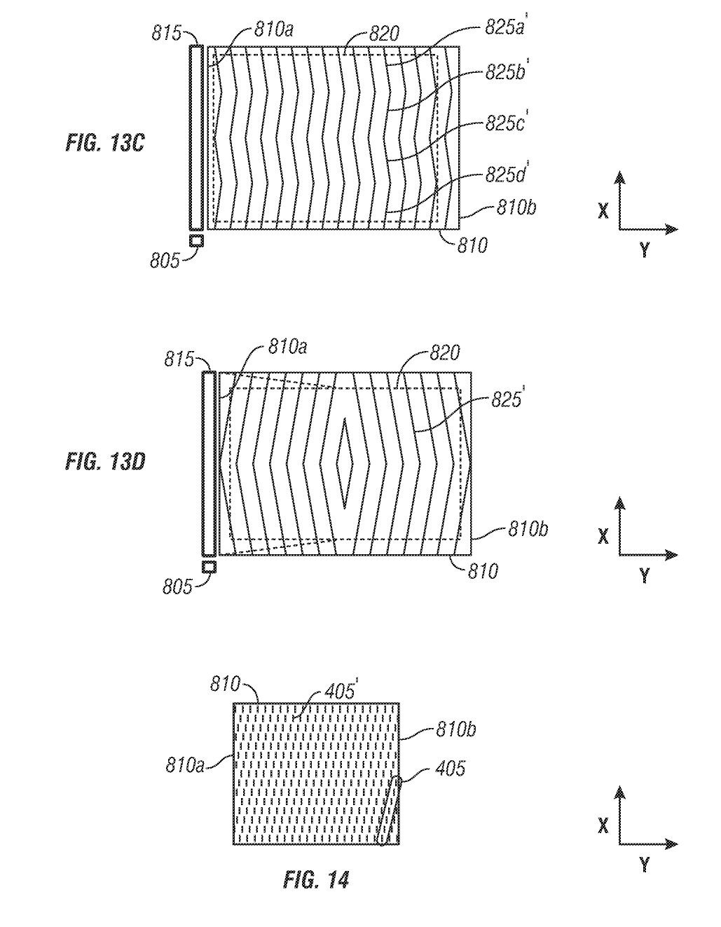

In some embodiments, a light guide 810 comprises turning features having portions or segments 825′ oriented in different directions. FIG. 13A, for example, shows a light guide 810 comprising a plurality of turning features 825 comprising a plurality of segments 825′ (e.g., linear segments). In each portion of the rectilinear paths, segments 825′ of turning features of the light guide 810 are rotated either counter-clockwise or clockwise from vertical. For example, a first segment may have a vector normal inclined at an angle of 10° above the horizontal and the second segment may have a vector normal declining at an angle of 10° below the horizontal. In some embodiments, a turning feature comprises more than two segments.

In some embodiments, the orientations of segments 825′ are substantially similar for different turning features 825, as shown in FIGS. 13A and 13C. In other embodiments, the orientations of the segments 825′ differ for at least two of the turning features 825, as shown in FIGS. 13B and 13D. In the embodiments shown in FIGS. 13B and 13D, there are two groups of turning features 825, wherein the orientations of the turning features 825 are substantially similar within each group. In some instances, a light guide 810 may comprise more than two groups of turning features 825. A first group of turning features 825 may be a mirror image of a second group of turning features 825.

Each turning feature 825 may comprise two segments 825′, as shown in FIGS. 13A and 13D or they may comprise more than two segments 825′, as shown in FIGS. 13B and 13C. In some embodiments, the number of segments 825′ per turning feature 825 varies for different turning features 825. In some embodiments, a light guide 810 comprises at least one turning feature 825 comprising a plurality of segments 825′ and at least one turning feature 825 of a single orientation. The segments 825′ may be configured to form an apex at the intersection of the segments 825′. In FIGS. 13A and 13D, the segments 825′ of each turning feature are arranged in a sideways V-shape.

FIGS. 13A-D each show a light guide 810 comprising a plurality of turning features comprising different portions or segments 825′, wherein the orientations of the segments 825′ vary across the length of the turning features. For example, a plurality of the turning features shown in the example light guides 810 of FIGS. 13B and C comprise four portions or segments 825a′-d′. At least two of the segments 825a′ and 825b′ within a turning feature are oriented in two different directions, both non-parallel to the first end 810a. In the light guide shown in FIG. 13D, two segments 825a′ and 825c′ have vector normals directed more toward the upper right corner and two segments 825b′ and 825d′ have vector normals directed more toward the lower right corner. The segments 825a′-d′ within a turning feature may be arranged to alternate segments 825a′-d′ of the first orientation with segments 825a′-d′ of the second orientation to yield a zig-zag shaped turning feature. A wide variety of other configurations are possible.

In the embodiments shown in FIGS. 13A-D, the average orientation of the light turning features 825 may be substantially parallel to the first end 810a of the light guide 810 adjacent to the light bar 815 and orthogonal to the length of the light guide 810. In some instances, the average orientation is the average orientation across all segments 825′ of the light guide 810. In some instances, the average orientation is the average orientation across all light turning features 825 or segments 825′. Accordingly, the average sum of the vector normal of the light turning features 825 and/or segments 825′ across the light guide 810, in some embodiments overlapping the display, may be substantially orthogonal to the first end 810a and/or parallel to the length of the light guide 810. However, in various embodiments, when the light turning features in the different sections are oriented with an angle to the first end 810a of the light guide 810, the dark region due to the edge shadow effect may be reduced or removed by having on average the orientation of the light turning features 825 and/or segments 825′ being normal to the propagation of light across the length of the light guide 810.

FIG. 14 shows a light guide 810 comprising a plurality of obliquely oriented turning element 405. Each turning element 825 comprises a plurality of features 405′. The orientation of the features 405′ is typically different from the orientation of the turning element 405. In some embodiments, the features 405′ are oriented vertically or in a direction parallel to the first edge 810a of the light guide 810. The length of each feature 405′ is small compared to the length of the turning element 405 or to the length of the first end 810a of the light guide. In some embodiments, the length of each feature 405′ is similar and/or less than to the resolution of a human eye. The length of each feature 405′ may be small enough such that the individual features 405′ are not visible to a human, and that the turning element 405 instead looks like a continuous line. In one instance, the length of one, more than one or all of the features 405′ is such that individual turning features are indistinguishable by an unaided human eye. An unaided human is one without the aid of an optical system with optical power, such as a magnifier or microscope. For example, a human may be unable to determine that a plurality of distinct turning features are present or may not be able to distinguish a single turning feature from adjacent turning features. The turning features 405 may have a length (in a direction parallel to the first side 810a of the light bar 810) that is less than 5%, 4%, 3%, 2%, 1%, 0.5%, 0.3%, 0.2%, 0.1%, 0.05%, or 0.01% of a width of the light guide 810. The turning features 405′ may have two ends that do not contact other turning features 405′ and/or ends and/or edges of the light guide 810. In some embodiments, features 405′ from a plurality of turning elements 405 are arranged in rows.

Each turning feature 405′ may comprise an exposed portion. The exposed portion is the portion of the turning feature 405′ which could turn light from the light bar incident at a normal angle. In the example shown in FIG. 14, the exposed portion of each turning feature 405′ is the entire length of the turning feature 405′. However, if all turning features were substantially longer in the downwards direction, the bottom portion of the turning features may be unexposed, as adjacent turning features 405′ in the turning elements 405 may obstruct the bottom portions. In some embodiments, centers of the exposed portion of a group of turning features in a diagonal turning element are arranged in a line or may be substantially linear. The line may be a diagonal line and/or non-normal and/or non-parallel with respect to the length of the light guide 810. In some embodiments, centers of the exposed portion of a side of the turning features in a diagonal turning element are arranged in a line or may be substantially linear. Accordingly, a side of the turning features 405′, such as an exposed side of the turning features may be arranged along the line. The turning features 405′ forming a plurality of turning elements 405 may be arranged along a plurality of parallel lines. At least about 10 lines (and 10 turning elements 405) may be included. Additionally, at least about 10 turning features 405′ may be included in each turning element 825. In some embodiments, the diagonal turning elements are more parallel to the width of the light guide than the length of the light guide (although being non-parallel to the width). In various embodiments, for example, the diagonal turning elements 405 are oriented at an angle of greater than 45°, 50°, 60°, 70°, 80°, or 90° with respect to the length of the light guide.

Light propagates from the first end 810a to the second end 810b of the light guide 810 at substantially normal incidence to the vertical orientation of the turning features 405′. This arrangement reduces the edge shadow effect as light is directed at substantially normal incidence to the vertical orientation of the turning features 405′ even in the corners at substantially normal incidence. However, the non-parallel orientation of the turning elements 405 can reduce or eliminate the Moiré interference pattern.

In some embodiments, systems described herein may further comprise a diffuser to, for example, further reduce the edge shadow effect. Additionally, a size and periodicity of the turning features in light guide 810 may be selected that yields a spatial frequency different from that of the pixel array 820 to, for example, further reduce the edge shadow effect.

A wide variety of other alternative configurations are also possible. For example, components (e.g., layers) may be added, removed, or rearranged. Similarly, processing and method steps may be added, removed, or reordered. Also, although the terms film and layer have been used herein, such terms as used herein include film stacks and multilayers. Such film stacks and multilayers may be adhered to other structures using adhesive or may be formed on other structures using deposition or in other manners.

Notably, in some embodiments, light propagation or turning feature orientation is described with reference to the first end 810a of the light guide, a length of the light guide 810, or a length of the light bar 815. For example, a turning feature may be described as being parallel to the first end 810a of the light guide and orthogonal to the length of the light guide 810. In some embodiments, the direction may be a direction orthogonal to a length of the light bar 815, a direction parallel to a length of the light guide 810, a direction parallel to a length of the pixel array 820, a direction orthogonal to the width of the light guide 810, a direction orthogonal to the width of the pixel array 820, a horizontal reference line, a direction parallel to a row of pixels (e.g., spatial light modulators), a direction orthogonal to a column of pixels, or a direction orthogonal to a border of the pixel array. Thus, other embodiments may include a direction as listed above. Similarly, a direction parallel to the first end 810a of the light guide may instead be a direction parallel to a length of the light bar 815, a direction orthogonal to a length of the light guide 810, a direction orthogonal to a length of the pixel array 820, a direction parallel to the width of the light guide 810, a direction parallel to the width of the pixel array 820, a vertical reference line, a direction orthogonal to a row of pixels (e.g., spatial light modulators), a direction parallel to a column of pixels, or a direction parallel to a border of the pixel array. Other reference lines, reference directions or other references may be used, and other variations are also possible.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. An illumination apparatus comprising:
a light source;
a light guide having first and second ends and a length therebetween such that light from the light source injected into said first end of the light guide propagates toward the second end, said light guide comprising non-overlapping first and second regions along said second end; and
a plurality of turning features in the light guide that reflect light incident thereon out the light guide, the turning features in said light guide generally facing a first region at said second end of said light guide such that light injected into said first end of said light guide is configured to be more efficiently reflected out from said first region of said light guide than from said second region,
wherein said light source is configured to direct more light into said light guide towards a second region at said second end of said light guide rather than towards the first region of said light guide thereby increasing uniformity of light output across said light guide.

2. The illumination apparatus of claim 1, wherein said light source comprises a light bar.

3. The illumination apparatus of claim 2, wherein said turning features are substantially nonparallel to the length of the light bar.

4. The illumination apparatus of claim 3, wherein light emitted from the light source has an asymmetric distribution that is on average substantially nonorthogonal to a length of the light bar.

5. The illumination apparatus of claim 1, wherein said turning features are substantially nonparallel to a width of the light guide.

6. The illumination apparatus of claim 5, wherein light emitted from the light source has an asymmetric distribution that is on average substantially nonorthogonal to the width of the light guide.

7. The illumination apparatus of claim 1, wherein said turning features are substantially nonorthogonal to the length of the light guide.

8. The illumination apparatus of claim 7, wherein light emitted from the light source has an asymmetric distribution that is on average nonparallel to the length of the light guide.

9. The illumination apparatus of claim 1, wherein said turning features are substantially nonparallel to the first end of the light guide.

10. The illumination apparatus of claim 9, wherein light emitted from the light source has an asymmetric distribution that is on average substantially nonorthogonal to the first end of the light guide.

11. The illumination apparatus of claim 1, wherein said turning features are arranged such that light propagating in a direction substantially perpendicular to the turning features is more efficiently reflected out from said first region of said light guide than from said second region.

12. The illumination apparatus of claim 1, wherein said turning features are linear and substantially parallel to each other.

13. The illumination apparatus of claim 1, wherein said first and second regions comprise first and second corners, respectively, of said light guide.

14. The illumination apparatus of claim 1, wherein the light source emits light in a primary lobe and a secondary lobe, and wherein the secondary lobe is non-normal to the first end of said light guide.

15. The illumination apparatus of claim 1, wherein the light guide is disposed with respect to a plurality of spatial light modulators such that said light turned out of said light guide illuminates the plurality of spatial light modulators.

16. The illumination apparatus of claim 15, wherein the plurality of spatial light modulators comprises an array of interferometric modulators, said array having a length and a width.

17. The illumination apparatus of claim 16, wherein said turning features are substantially nonorthogonal to the length and width of the array.

18. The illumination apparatus of claim 17, wherein light emitted from the light source has an asymmetric distribution that is on average substantially nonparallel to the length of the array.

19. The illumination apparatus of claim 16, wherein said turning features are substantially nonparallel to the length and width of the array.

20. The illumination apparatus of claim 19, wherein light emitted from the light source has an asymmetric distribution that is on average substantially nonorthogonal to the length of the array.

21. The illumination apparatus of claim 16, wherein said array has rows and columns, and said turning features are substantially nonorthogonal and nonparallel to said rows and columns.

22. The illumination apparatus of claim 17, further comprising an array of spatial light modulators, said array having a length and a width.

23. The illumination apparatus of claim 22, wherein said spatial light modulators comprise interferometric modulators.

24. The illumination apparatus of claim 22, wherein the orientation of said turning features is substantially nonparallel to said length and width of said spatial light modulator array.

25. The illumination apparatus of claim 22, wherein said spatial light modulator array comprises rows and columns, and wherein the orientation of said turning features is substantially nonparallel to said rows and columns.

26. An illumination apparatus comprising:
a light guide having first and second ends and a length therebetween such that light injected into said first end propagates toward a second end, said light guide having a width and thickness; and
a plurality of turning features disposed on a first side of the light guide, said turning features comprising sloping sidewalls that reflect light incident thereon out a second side of the light guide, each of said turning features comprising a plurality of linear segments, at least one first segment of said plurality of segments being oriented obliquely with respect to at least one second segment of said plurality of segments,
wherein none of said segments intersect more than two other turning features.

27. The illumination apparatus of claim 26, further comprising a light source that has an output region having a length and that is configured to emit light therefrom toward said first end of said light guide.

28. The illumination apparatus of claim 27, wherein the light source comprises a light bar.

29. The illumination apparatus of claim 28, wherein said turning features are oriented in a direction that is substantially nonparallel to the length of the light bar.

30. The illumination apparatus of claim 26, wherein said segments are oriented in a direction that is substantially nonparallel to the width of the light guide.

31. The illumination apparatus of claim 26, wherein said turning segments are arranged in the shape of a V.

32. The illumination apparatus of claim 31, wherein said plurality of turning features comprises at least one turning feature comprising a pair of segments that are obliquely arranged and are disposed with respect to each other to intersect to form a V-shape.

33. The illumination apparatus of claim 26, wherein said plurality of segments zig-zag.

34. The illumination apparatus of claim 33, wherein said first segment intersects with said second segment.

35. The illumination apparatus of claim 26, wherein said plurality of turning features comprise at least 10 turning features.

36. The illumination apparatus of claim 26, wherein one or more of the turning features extend from a first edge of the light guide to a second edge of the light guide, the first and second edges being substantially nonparallel to the first and second ends.

37. The illumination apparatus of claim 36, wherein at least one of the one or more turning features that extends from a first edge of the light guide to a second edge of the light guide comprises two or more linear turning feature segments, wherein the two or more of the linear turning feature segments are positioned end to end.

38. The illumination apparatus of claim 37, wherein the at least one of the one or more turning features comprises a first linear turning feature segment oriented in a first direction and a second linear turning feature segment oriented in a second direction, and wherein said first direction is substantially different from said second direction.

39. The illumination apparatus of claim 26, wherein said turning features do not intersect each other.

40. The illumination apparatus of claim 26, further comprising an array of spatial light modulators, said array having a length and a width.

41. The illumination apparatus of claim 40, wherein said spatial light modulators comprise interferometric modulators.

42. The illumination apparatus of claim 40, wherein the orientation of said turning feature segments is substantially nonparallel to said length and width of said spatial light modulator array.

43. The illumination apparatus of claim 40, wherein said spatial light modulator array has rows and columns, and the orientation of said turning feature segments is substantially nonparallel to said rows and columns.

44. The illumination apparatus of claim 40, wherein the width of said light guide is substantially parallel to said width of said spatial light modulator array.

45. An illumination apparatus comprising:
a light guide having first and second ends and a length therebetween such that light injected into said first end propagates toward a second end; and
a plurality of diagonal turning elements, each diagonal turning element comprising a plurality of turning features disposed on a first side of the light guide, said turning features comprising sloping sidewalls that reflect light incident thereon out a second side of the light guide,
wherein one side of the turning features in each diagonal turning element being arranged along a line, the line being non-normal and non-parallel to the length of the light guide, and
wherein the orientation of said turning features in said diagonal turning elements are different from the orientation of the respective diagonal turning element.

46. The illumination apparatus of claim 45, wherein the turning features are substantially orthogonal to the length of the light guide.

47. The illumination apparatus of claim 45, wherein the center of the sides of the turning features are arranged along the line.

48. The illumination apparatus of claim 45, wherein the centers of exposed portions of the turning features are arranged along the line, the exposed portions being portions that are exposed to the first end of the light guide.

49. The illumination apparatus of claim 45, wherein the turning features of each diagonal turning element are offset from adjacent turning features in the diagonal turning element in a direction substantially perpendicular to the first side of the light guide.

50. The illumination apparatus of claim 45, wherein the turning features do not intersect each other.

51. The illumination apparatus of claim 45, wherein said diagonal turning elements are parallel to each other.

52. The illumination apparatus of claim 45, wherein said plurality of diagonal turning elements comprise at least ten diagonal turning elements.

53. The illumination apparatus of claim 45, wherein the length of said turning features is such that individual turning features within each of the diagonal turning elements are undistinguishable by an unaided human eye.

54. The illumination apparatus of claim 45, wherein successive turning features within the diagonal turning elements do not overlap along the direction parallel to the first side of the light guide.

55. The illumination apparatus of claim 45, further comprising a light source that has an output region having a length and that is configured to emit light therefrom toward said first end of said light guide.

56. The illumination apparatus of claim 55, wherein the light source comprises a light bar.

57. The illumination apparatus of claim 56, wherein said turning features are oriented in a direction that is substantially parallel to a length of the light bar.

58. The illumination apparatus of claim 45, wherein said turning features are oriented in a direction that is substantially parallel to the width of the light guide.

59. The illumination apparatus of claim 45, wherein said turning features are oriented in a direction that is substantially orthogonal to the length of the light guide.

60. The illumination apparatus of claim 45, further comprising an array of spatial light modulators, said array having a length and a width.

61. The illumination apparatus of claim 60, wherein said spatial light modulators comprise interferometric modulators.

62. The illumination apparatus of claim 60, wherein the orientation of said turning features is substantially nonparallel to said length of said spatial light modulator array.

63. The illumination apparatus of claim 60, wherein the orientation of said turning features is substantially parallel to said width of said spatial light modulator array.

64. The illumination apparatus of claim 60, wherein the width of said light guide is substantially parallel to said width of said spatial light modulator array.

65. The illumination apparatus of claim 60, wherein the spatial light modulator array comprises rows and columns, and wherein the orientation of said turning features is substantially parallel to said columns of said spatial light modulator array.

66. The illumination apparatus of claim 60, the spatial light modulator array comprises rows and columns, and wherein the rows of turning features are substantially parallel to said rows of said spatial light modulator array.

67. The illumination apparatus of claim 45, wherein the diagonal turning elements are oriented at an angle of more than 45° with respect to the length of the light guide.

68. The illumination apparatus of claim 45, wherein the diagonal turning elements are more parallel to the width of the light guide than the length of the light guide.

69. An illumination apparatus comprising:
a light guide having first and second ends and a length therebetween such that light injected into said first end propagates toward a second end; and
a plurality of turning features disposed on a first side of the light guide, said turning features comprising sloping sidewalls that reflect light incident thereon out a second side of the light guide, said turning features comprising linear paths orthogonal to the length of the light guide, said turning features having a first length, said turning features having two ends that do not contact other turning features or ends or edges of the light guide,
wherein said first length is configured such that the individual turning features are undistinguishable by an unaided human eye.

70. The illumination apparatus of claim 69 wherein the linear paths are oriented at an angle of more than 45° with respect to the length of the light guide.

71. The illumination apparatus of claim 69, wherein the linear paths are more parallel to the width of the light guide than the length of the light guide.

72. An illumination apparatus comprising:
a means for producing light;
a means for guiding light having first and second ends and a length therebetween such that light from the light-producing means injected into said first end of the light-guiding means propagates toward the second end, said light-guiding means comprising non-overlapping first and second regions along said second end; and
a plurality of means for turning light in the light-guiding means that reflect light incident thereon out the light-guiding means, the light-turning means in said light-guiding means generally facing a first region at said second end of said light-guiding means such that light injected into said first end of said light-guiding means is configured to be more efficiently reflected out from said first region of said light-guiding means than from said second region,
wherein said light-producing means is configured to direct more light into said light-guiding means towards a second region at said second end of said light-guiding means rather than towards the first region of said light-guiding means thereby increasing uniformity of light output across said light-guiding means.

73. The illumination apparatus of claim 72, wherein the light-producing means comprises a light source, or the light-guiding means comprises a light guide, or the light-turning means comprise turning features in the light-guiding means.

74. An illumination apparatus comprising:
means for guiding light having first and second ends and a length therebetween such that light injected into said first end propagates toward a second end, said light-guiding means having a width and thickness; and
a plurality of means for turning light disposed on a first side of the light-guiding means, said light-turning means comprising means for reflecting light incident thereon out a second side of the light-guiding means, each of said light-turning means comprising a plurality of linear segments, at least one first segment of said plurality of segments being oriented obliquely with respect to at least one second segment of said plurality of segments,
wherein none of said segments intersect more than two other segments.

75. The illumination apparatus of claim 74, wherein the light guiding means comprises a light guide, or the light reflecting means comprise sloping sidewalls, or the light turning means comprises a light turning feature.

76. An illumination apparatus comprising:
means for guiding light having first and second ends and a length therebetween such that light injected into said first end propagates toward a second end; and
a plurality of diagonal means for directing light, each diagonal light-directing means comprising a plurality of means for turning light disposed on a first side of the light-guiding means, said light-turning means comprising means for reflecting light incident thereon out a second side of the light-guiding means.

77. The illumination apparatus of claim 76, wherein the light guiding means comprises a light guide, or said light reflecting means comprises sloping sidewalls, or the light turning means comprises a light turning feature.

78. An illumination apparatus comprising:
means for guiding light having first and second ends and a length therebetween such that light injected into said first end propagates toward a second end; and
a plurality of means for turning light disposed on a first side of the light guiding means, said light turning means comprising means for reflecting light incident thereon out a second side of the light guide, said light turning means comprising linear paths orthogonal to the length of the light guiding means, said light turning means having a first length, said light turning means having two ends that do not contact other light turning means or ends or edges of the light guiding means,
wherein said first length is configured such that the individual light turning means are undistinguishable by an unaided human eye.

79. The illumination apparatus of claim 78, wherein the light guiding means comprises a light guide, or the light turning means comprises a light turning feature, or said light reflecting means comprises sloping sidewalls.
